(19) United States
(12) Patent Application Publication
(10) Pub. No.: US 2012/0284036 A1
(43) Pub. Date: Nov. 8, 2012

(54) SYSTEM AND METHOD FOR LINKING TOGETHER AN ARRAY OF BUSINESS PROGRAMS

(75) Inventor: Jon C. Evans, Venice, FL (US)

(73) Assignee: eComSystems, Inc., Sarasota, FL (US)

(21) Appl. No.: 13/463,508

(22) Filed: May 3, 2012

Related U.S. Application Data
(60) Provisional application No. 61/482,006, filed on May 3, 2011.

(51) Int. Cl. G06Q 30/02; G06F 7/00

(52) U.S. Cl. 705/1.1; 707/812; 707/E17.044

(57) ABSTRACT

A system, method and computer readable media for disseminating data from a first entity to one or more additional entities is disclosed. The method comprises compiling a database of records of business transactions, receiving data from a business transaction recording system of a first entity, parsing the received data to determine if the received data is a new business transaction, automatically updating the database to reflect the new business transaction, and automatically disseminating the new business transaction to one or more additional entities.

### REFERENCE TO RELATED APPLICATIONS

This application claims priority to U.S. provisional application Ser. No. 61/482006, filed May 3, 2011, entitled “System and Method for Linking Together an Array of Business Programs,” which is hereby specifically and entirely incorporated by reference.

### BACKGROUND OF THE INVENTION

1. Field of the Invention

This invention relates to the field of business management, and more particularly to linking together numerous business programs, systems and services.

2. Description of the Background

Important to the sale of any product or service is the control of four basic attributes: the product or service; the places where buyers can find the product or service (or the distribution channels to get the product or service in front of the buyers); the price; and the product or service's promotion (or advertising). These elements are often referred to as the “Four Ps” of marketing and they constitute the marketing mix.

The Product is a tangible object or an intangible service. Every product is subject to a life-cycle including a growth phase followed by an eventual period of decline as the product approaches market saturation. To retain its competitiveness in the market, product differentiation is required and is one of the strategies to differentiate a product from its competitors.

The Price is the amount a customer pays for the product or service. A business may adjust the price of product in relation to other stores that have the same product or the products sales statistics.

The Place (or placement) represents where a product can be purchased. It is often referred to as the distribution channel. It can include any physical store as well as virtual stores on the Internet.

Promotion represents all of the communications that a marketer may use in the marketplace. One aspect of promotion is advertising.

In many industries, each of the elements of the marketing mix is controlled by different people, departments, or even companies. Changes made to one element are often not communicated to other elements. Such miscommunication can lead to incorrect pricing, lower sales, consumer confusion, inadequate supply, management or distribution inefficiencies, and other missed business opportunities. Therefore, it is desirable to have a single system that simultaneously provides and manages all of the elements of a marketing mix.

### SUMMARY

The present invention overcomes the problems and disadvantages associated with current strategies and designs and provides new systems and methods of managing businesses.

One embodiment of the invention is directed to a system for disseminating data from a first entity to one or more additional entities. The system comprises a processor, at least one database storing records of business transactions, wherein the database is in communication with the processor, and software executing on the processor. The software receives data from a business transaction recording system of a first entity, parses the received data to determine if the received data is a new business transaction, automatically updates the database to reflect the new business transaction, and automatically disseminates the new business transaction to one or more additional entities.

Preferably, each entity is one of a retailer, consumer, distributor, manufacturer, wholesaler, producer, supplier, contractor, administrator or service provider. In the preferred embodiment, the business transaction recording system is at least one of an advertising and promotion system, a marketing and communication system, a point-of-sale (POS) system, an advertising program, a website, a loyalty program, Internet access, an ordering system, an education and training program, social media, a printing service, a mailing service, a distribution service, a media product, a data analysis system, a human resources service, a credit service, an insurance service, an accounting service, a payroll service and a management service.

Preferably, the processor is coupled to at least one of a local area network, a wide area network, a metropolitan area network, an intranet, or the Internet. In the preferred embodiment, the business transactions include at least one of products sold, quantity of product sold, pricing of the product, product discounts, products advertised, in which form products were advertised, which products sold were advertised, margins, website traffic, user profile, customer information, statistical data, historical data, transactional data, demographics, analytics, which ads were viewed online, which products were added to a shopping list, shopping cart, or purchased, inventory levels, age and quantities, competitive information, management criteria, manufacturing details, distributor information, industry trends, human resources, accounting, payroll, purchasing, insurance, printing, mailing, delivery, research and development, training, production, promotions, sales and marketing.

The software preferably provides an entity a business marketing plan. The business marketing plan is preferably based on at least one of the entity's profile, demographic information, the data stored in the database, marketing profile information. Preferably, the business marketing plan is updated based on changes to the database. The business marketing plan may include at least one of suggested budgets, suggested purchasing levels, suggested transactional timing, suggested inventory levels, suggested billing cycle, suggested business services, suggested synergistic partnerships, suggested expense increase or reduction, suggested advertising vehicles, suggested marketing message, suggested target market, suggested sale location, suggested product mix and adjustments, suggested pricing, suggested pricing adjustment, and suggested promotional pricing.

The system preferably further comprises the software outputting at least one report. Preferably, the at least one report contains at least one of sales by location, wholesaler, distributor, retailer, region, state, at large or other demographic area, price comparison, inventory level, expense, sales by customer type, profile or demographic, online sales by demographic, sales of promotional priced items, sales compared to competition, product manufactured, warehoused, distributed or shipped by region, state, or other statistic, analytic or demographic.

Another embodiment of the invention is directed to a method for business management. The method comprises, on a processor, compiling a database of records of business transactions, receiving data from a business transaction recording system of a first entity, parsing the received data to determine if the received data is a new business transaction, automatically updating the database to reflect the new business transaction, and automatically disseminating the new business transaction to one or more additional entities.

In a preferred embodiment, each entity is one of a retailer, consumer, wholesaler, producer, supplier, contractor, distributor, manufacturer, administrator or service provider. Preferably, the business transaction recording system is chosen from the group comprising advertising and promotion systems, marketing and communication systems, point-of-sale (POS) systems, advertising programs, websites, loyalty programs, Internet access, ordering systems, education and training programs, social media, email programs, software systems, printing services, mailing services, distribution services, media products, data analysis systems, and third party services including human resources, credit, insurance, accounting, payroll and management services.

Preferably, the processor is coupled to at least one of a local area network, a wide area network, a metropolitan area network, an intranet, or the Internet. The business transactions preferably include at least one of products sold, quantity of product sold, pricing of the product, product discounts, products advertised, in which form products were advertised, which products sold were advertised, margins, website traffic, customer profile, demographics, analytics, which ads were viewed online, which products were added to a shopping list, shopping cart, or purchased, inventory levels, age and quantities, competitive information, management criteria, manufacturing details, distributor information, industry trends, human resources, accounting, payroll, purchasing, insurance, printing, mailing, delivery, research and development, training, production, promotions, sales and marketing.

Preferably, the method further comprises providing an entity a business marketing plan. The business marketing plan is preferably based on at least one of the entity's profile, demographic information, the data stored in the database, marketing profile information. Preferably, the business marketing plan is updated based on changes to the database. In a preferred embodiment, the business marketing plan includes at least one of suggested budgets, suggested purchasing levels, suggested transactional timing, suggested inventory levels, suggested billing cycle, suggested business services, suggested synergistic partnerships, suggested expense increase or reduction, suggested advertising vehicles, suggested marketing message, suggested target market, suggested sale location, suggested product mix and adjustments, suggested retail pricing, suggested pricing adjustment, and suggested promotional pricing.

Preferably, the method further comprises outputting at least one report. The at least one report preferably contains at least one of retail sales by location, wholesaler, distributor, retailer, region, state, at large or other demographic area, price comparison, inventory level, expense, sales by customer type, profile or demographic, online sales by demographic, sales of promotional priced items, sales compared to competition, product manufactured, warehoused, distributed or shipped by region, state, or other statistic, analytic or demographic.

Another embodiment of the invention is directed to a computer-readable media containing program instructions for business management. The computer-readable media causes a computer to compile a database of records of business transactions, receive data from a business transaction recording system of a first entity, parse the received data to determine if the received data is a new business transaction, automatically update the database to reflect the new business transaction, and automatically disseminate the new business transaction to one or more additional entities.

Preferably, each entity is one of a retailer, consumer, wholesaler, producer, supplier, contractor, distributor, manufacturer, administrator or service provider. In a preferred embodiment, the business transaction recording system is chosen from the group comprising advertising and promotion systems, marketing and communication systems, point-of-sale (POS) systems, advertising programs, websites, loyalty programs, Internet access, ordering systems, education and training programs, social media, email programs, software systems, printing services, mailing services, distribution services, media products, data analysis systems, and third party services including human resources, credit, insurance, accounting, payroll and management services.

In a preferred embodiment, the processor is coupled to at least one of a local area network, a wide area network, a metropolitan area network, an intranet, or the Internet. Preferably, the business transactions include at least one of products sold, quantity of product sold, pricing of the product, product discounts, products advertised, in which form products were advertised, which products sold were advertised, margins, website traffic, customer profile, demographics, analytics, which ads were viewed online, which products were added to a shopping list, shopping cart, or purchased, inventory levels, age and quantities, competitive information, management criteria, manufacturing details, distributor information, industry trends, human resources, accounting, payroll, purchasing, insurance, printing, mailing, delivery, research and development, training, production, promotions, sales and marketing.

The computer-readable media preferably further causes the processor to provide an entity a business marketing plan. Preferably, the business marketing plan is based on at least one of the entity's profile, demographic information, the data stored in the database, marketing profile information. The business marketing plan is preferably updated based on changes to the database. Preferably, the business marketing plan includes at least one of suggested budgets, suggested purchasing levels, suggested transactional timing, suggested inventory levels, suggested billing cycle, suggested business services, suggested synergistic partnerships, suggested expense increase or reduction, suggested advertising vehicles, suggested marketing message, suggested target market, suggested sale location, suggested product mix and adjustments, suggested retail pricing, suggested pricing adjustment, and suggested promotional pricing.

Preferably, the computer-readable media further causes the processor to output at least one report. The at least one report preferably contains at least one of sales by location, wholesaler, distributor, retailer, region, state, at large or other demographic area, price comparison, inventory level, expense, sales by customer type, profile or demographic, online sales by demographic, sales of promotional priced items, sales compared to competition, product manufactured, warehoused, distributed or shipped by region, state, or other statistic, analytic or demographic.

Another embodiment of the invention is directed to a system disseminating data from a first business transaction system or more additional business transaction systems. The system comprises a processor, at least one database storing records of business transactions, wherein the database is in communication with the processor, and software executing on the processor. The software receives data from a first business transaction system of a first entity, parses the received data to determine if the received data is a new business transaction, automatically updates the database to reflect the new business transaction, and automatically disseminates the new business transaction to one or more additional business transaction systems. Preferably, the data is automatically disseminated to one or more additional entities.

Other embodiments and advantages of the invention are set forth in part in the description, which follows, and in part, may be obvious from this description, or may be learned from the practice of the invention.

### BRIEF DESCRIPTION OF THE DRAWINGS

The invention is described in greater detail by way of example only and with reference to the attached drawings, in which:

FIG. 1 illustrates an example system embodiment;

FIG. 2 illustrates the general layout of a preferred business management system;

### DETAILED DESCRIPTION

As embodied and broadly described herein, the disclosures herein provide detailed embodiments of the invention. However, the disclosed embodiments are merely exemplary of the invention that may be embodied in various and alternative forms. Therefore, there is no intent that specific structural and functional details should be limiting, but rather the intention is that they provide a basis for the claims and as a representative basis for teaching one skilled in the art to variously employ the present invention.

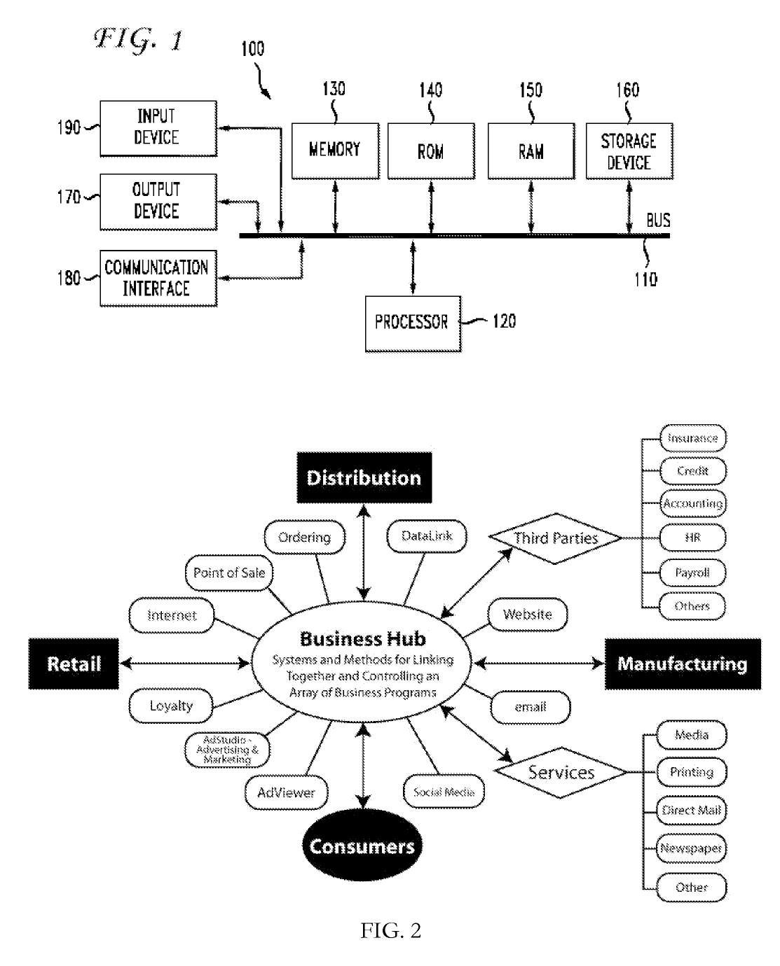

With reference to FIG. 1, an exemplary system includes at least one general-purpose computing device 100, including a processing unit (CPU) 120 and a system bus 110 that couples various system components including the system memory such as read only memory (ROM) 140 and random access memory (RAM) 150 to the processing unit 120. Other system memory 130 may be available for use as well. It can be appreciated that the invention may operate on a computing device with more than one CPU 120 or on a group or cluster of computing devices networked together to provide greater processing capability. The system bus 110 may be any of several types of bus structures including a memory bus or memory controller, a peripheral bus, and a local bus using any of a variety of bus architectures. A basic input/output (BIOS) stored in ROM 140 or the like, may provide the basic routine that helps to transfer information between elements within the computing device 100, such as during start-up. The computing device 100 further includes storage devices such as a hard disk drive 160, a magnetic disk drive, an optical disk drive, tape drive or the like. The storage device 160 is connected to the system bus 110 by a drive interface. The drives and the associated computer readable media provide nonvolatile storage of computer readable instructions, data structures, program modules and other data for the computing device 100. The basic components are known to those of skill in the art and appropriate variations are contemplated depending on the type of device, such as whether the device is a small, handheld computing device, a desktop computer, a computer server, a handheld scanning device, or a wireless devices, including wireless Personal Digital Assistants (“PDAs”) (e.g., Palm™ VII, Microsoft's Windows, Research in Motion's Blackberry™ an Android™ device, Apple's iPhone™), tablet devices (Samsung's Galaxy™, Apple's iPad™), wireless web-enabled phones, other wireless phones, etc.

Although the exemplary environment described herein employs the hard disk, it should be appreciated by those skilled in the art that other types of computer readable media which can store data that are accessible by a computer, such as magnetic cassettes, flash memory cards, digital versatile disks, cartridges, random access memories (RAMs), read only memory (ROM), a cable or wireless signal containing a bit stream and the like, may also be used in the exemplary operating environment.

To enable user interaction with the computing device 100, an input device 190 represents any number of input mechanisms, such as a microphone for speech, a touch-sensitive screen for gesture or graphical input, keyboard, mouse, motion input, speech and so forth. The device output 170 can be one or more of a number of output mechanisms known to those of skill in the art, for example, printers, monitors, projectors, speakers, and plotters. In some embodiments, the output can be via a network interface, for example uploading to a website, emailing, attached to or placed within other electronic files, and sending an SMS or MMS message. In some instances, multimodal systems enable a user to provide multiple types of input to communicate with the computing device 100. The communications interface 180 generally governs and manages the user input and system output. There is no restriction on the invention operating on any particular hardware arrangement and therefore the basic features here may easily be substituted for improved hardware or firmware arrangements as they are developed.

For clarity of explanation, the illustrative system embodiment is presented as comprising individual functional blocks (including functional blocks labeled as a “processor”). The functions these blocks represent may be provided through the use of either shared or dedicated hardware, including, but not limited to, hardware capable of executing software. For example the functions of one or more processors presented in FIG. 1 may be provided by a single shared processor or multiple processors. (Use of the term “processor” should not be construed to refer exclusively to hardware capable of executing software.) Illustrative embodiments may comprise microprocessor and/or digital signal processor (DSP) hardware, read-only memory (ROM) for storing software performing the operations discussed below, and random access memory (RAM) for storing results. Very large scale integration (VLSI) hardware embodiments, as well as custom VLSI circuitry in combination with a general purpose DSP circuit, may also be provided.

Embodiments within the scope of the present invention may also include computer-readable media for carrying or having computer-executable instructions or data structures stored thereon. Such computer-readable media can be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium which can be used to carry or store desired program code means in the form of computer-executable instructions or data structures. When information is transferred or provided over a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable media.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Those of skill in the art will appreciate that other embodiments of the invention may be practiced in network computing environments with many types of computer system configurations, including personal computers, hand-held devices, multi-processor systems, microprocessor-based or programmable consumer electronics, network PCs, minicomputers, mainframe computers, and the like. Networks may include the Internet, one or more Local Area Networks (“LANs”), one or more Metropolitan Area Networks (“MANs”), one or more Wide Area Networks (“WANs”), one or more Intranets, etc. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

In the preferred embodiment, a user utilizes an Internet connection in order to access a website on a host computer. The different programs may be physically hosted together or separately. The web site may, for example, be maintained and hosted by a manufacturer, a supplier, or an Internet Service Provider. The website, when accessed, may request a user to log into the site by entering a username and password. In the preferred embodiment, users will log in using a User Name and Password. However, in certain embodiments, additional information can be required, for example store number or company identification. The User Name and Password can be an email address or combination of letters, numbers, and/or symbols. Preferably, each User Name is unique. Based on user identification, access to the system can be determined. Furthermore, based on user identification, a user's preferences, accessible databases, and other resources the user has access to, is uploaded.

The preferred embodiment of the system of the invention is a business management or transaction system or business hub that provides and links-together an array of business programs. See FIG. 2. Business programs may include, but are not limited to advertising and promotion system, a marketing and communication system, a point-of-sale (POS) system, an advertising program, a website, a loyalty program, Internet access, an ordering system, an education and training program, social media, a printing service, a mailing service, a distribution service, a media product, a data analysis system, a human resources service, a credit service, an insurance service, an accounting service, a payroll service and a management service. Other systems and programs utilized in the retail environment may also be provided and linked in the business hub. In the preferred embodiment, each component of the business hub may be modified independently of the other components. Preferably the system includes a web-based software solution capable of receiving, storing, and presenting sales and inventory data and profile information about the participants.

The business hub is preferably accessible to participating entities, such as retailers, consumers, distributors, manufacturers, wholesalers, producers, suppliers, contractors, administrators, or service providers. The business hub preferably receives, stores, aggregates, and presents POS, advertising, ordering, loyalty and other transactional data in ways that assist retailers, manufacturers, and distributors make business decisions. The business decisions may be based on trends, market demand and production schedules.

In the preferred embodiment, the business hub is based on Service Oriented Architecture (SOA). Each service in an SOA implementation is a building block. The service is preferably part of the solution, an autonomous business system that is able to accept requests and the interoperability is governed by various industry standards. In the preferred embodiment, the business hub is internet based, however due to technical limitations of some retailers (e.g. cash registers that are not networked or when internet service is interrupted), the business hub can work offline and then update and synchronize when a connection is re-established.

Many retail operators utilize a point of sale system to control sales transactions, inventory, etc., linked to an accounting software system. Data is captured on a transactional basis and stored within a database. In the preferred embodiment, the data can be spread out over multiple tables within the database. There can be one database or multiple linked databases. This data can be extracted and provided in a variety of methods. Product pricing and promotional discounts are updated in a POS system through a spreadsheet, data import or as manual input. This information can be automatically or manually exported into a data interface to create an advertising campaign, including a circular, flyer(s), email blast, signage, social media and SMS text. Or, data from an ad can be exported from an advertising system into POS and uploaded as a price change to create promotional pricing. Data from one component of the business hub may be integrated into other components to increase the efficiency of accessing, coordinating, and performing multiple business functions previously performed independently. The business hub gathers and stores data from every service and transaction which is available to system users.

A main server may contain life to date data for each client. The main server database can be used for web-based reporting as well as the source for service queries. In addition, it may be the backup for client data. The main server database can be backed up hourly, daily, weekly, in real time, or at another time interval to the hosting company's storage facilities, as well as being co-located at an alternate hosting site. Furthermore, in a preferred embodiment, a cloud database (e.g. Microsoft's Azure) can be utilized.

For a smaller store requiring only one workstation functioning as a cash register and administrative reporting station, an embedded database can be used. When in the disconnected (e.g. from the Internet) state the application can rely solely on the embedded database. When the connection is restored, the application can synchronize the embedded database with the main server database.

Installations requiring more than one administrative or cash register position preferably use a local server instance running on a dedicated server. This server may be able to accommodate up to, for example, 10 GB of data and remain in synch with the main server database as long as Internet connectivity is present. The system may also include secure data transfer interfaces (e.g. web services) that can be exposed to the various components (e.g. applications) to facilitate sharing of information between the components.

For those multi-station installations that use laptops to act as mobile POS stations, each laptop preferably will contain an embedded database that will synch with the local database.

As decisions are made and transactions occur, such as products sold, quantity of product sold, pricing of the product, product discounts, products advertised, in which form products were advertised, which products sold were advertised, margins, website traffic, user profile, customer information, statistical data, historical data, transactional data, demographics, analytics, which ads were viewed online, which products were added to a shopping list, shopping cart, or purchased, inventory levels, age and quantities, competitive information, management criteria, manufacturing details, distributor information, industry trends, human resources, accounting, payroll, purchasing, insurance, printing, mailing, delivery, research and development, training, production, promotions, sales, and marketing, the decisions and transactions are captured by the business hub. In the preferred embodiment, the information is “pushed” to the business hub. For example, the retailers' POS system initiate uploads to the business hub.

Participating retailers preferably will be able to choose which manufacturers and distributors the retailers share their information with. Preferably, the identity of the retailers will be protected by the business hub displaying only POS information within a geographical area.

A data exchange program preferably accumulates data from all programs utilized in real time or at other time intervals. The system preferably will be able to receive data feeds from suppliers and import them into the database. The data exchange program analyzes this data and presents it in an understandable, actionable format modified to the specifications of the various recipients. Filters, search criteria and reporting options are presented to narrow and specify analysis. The data may be exposed on differing levels based on the retailer agreement. Retailer participation inherently provides base information into the business hub, such as overall sales, pricing, etc., without exposing retailer identity and other more confidential information. Additionally, a retailer may agree to provide more detailed information in exchange for product discounts, guaranteed fulfillment, priority status, etc.

The business hub and its programs may be provided to Retailers, Distributors, Manufacturers, Vendors or other industry-related entities which link all entities together with valuable information.

### Distributors

Distributors may be a participant in the program or may offer the business hub products and services to their retails, wholesalers or distribution network as a program. POS data may be updated and delivered on a regular basis. Promotions may be merchandised and offered to retailers on a systematic basis. Product discounts tied to these promotions may also be offered and communicated through the business hub. Product orders are facilitated as well as drop ship orders from retailers.

### Manufacturers

Manufacturers may be a participant in the program or may offer the business hub products and services to their personnel, retail, wholesale, or distribution network as a program.

Manufacturers use the business hub connections to analyze and understand current and emerging retail trends, competitive information, consumer demographics, market conditions and sales opportunities. This analysis may be used to influence research and development activities, manufacturing and product output, inventory levels, distribution, sales and marketing and other business decisions.

Manufacturers may merchandise promotions and provide them directly to retailers or through distributor programs. POS data may be updated and delivered on a regular basis. Product discounts tied to these promotions may also be offered and communicated through the business hub. Direct product orders may be facilitated as well.

### Retailers

Retailers use the business hub's services including POS, advertising, loyalty, product ordering, website and other programs to run their business day-to-day. Communications, data, program updates, etc. provided by distributors and manufacturers keep them updated and current. Participating retailer may go through a set-up process that includes completing a retailer profile. The retailers may also complete a marketing plan. The marketing plan may include desired growth rate, the retailer's service area, and the desired marketing budget.

The business hub can compile the retailer's profile, demographic information, database of collected industry data, and marketing profile information to provide a marking plan. The marketing plan may include, but is not limited to, suggested budgets, suggested advertising vehicles, suggested product mix adjustment, suggested pricing adjustment (if competitive profiles and pricing is available, this will feed the suggested pricing adjustment), and suggested promotional pricing based on time of year. For example, if the retailer is in the business of selling a particular set of products, the marketing plan may suggest a second set of products for the retailer to sell that complements the first set of products. Preferably, the ability to adjust prices by group and by percentage will be present. Furthermore, users will preferably have the ability to make changes over a range of data by dragging the mouse selection over a region of data.

When the marketing plan has been accepted, the program can provide daily, weekly, or ongoing tips, encouragement and deadline information in a pop-up desktop app, email, text, etc. to keep the retailer on-track to accomplish their goals. As POS transactional data is gathered, the original sales, average sale, number of unique customers, or other data, the retailer's profile is automatically updated with actual information. This information is merged into the marketing plan to keep it updated and on target. For example, if the data compiled by the business hub shows that sales of a specific product have slowed and the retailer has an abundance of the product in inventory, the updated marking plan may suggest lowering the price of the product or to stop ordering the product from a distributor.

Comparisons to other retailers can be reported at any time to understand products sold, pricing, associated or supporting products sold (e.g. soda and chips), what products other retailers may be selling that the current retailer does not carry, or other data. The comparison reports may be segmented by, for example, other retailers that match the store profile, other retailers that match the store demographic area, other retailers that match the store's sales volume, and other retailers in the store's state, regional area, or local area. For example, if the data compiled by the business hub shows that competitors of a retailer within a specific radius have all decreased the price of a specific product, the marketing report may suggest that the retailer likewise decrease the price of the product.

The data exchange program analyzes the data to provide understandable and actionable reports. Retailers may receive monthly (or other reoccurring) reports with, for example, graphs, pie charts, summaries and positive/negative production, and trends analysis. The reports will make suggestions of what to do to improve position, maintain momentum, stay on track with the marketing plan, or other advice.

The analysis may also be made available to manufacturers to understand purchasing trends, retail sales, retail pricing, promotional influence, or other business related matters. The information will help shape research and development efforts, product introductions, manufacturing rates, marketing efforts, pricing, inventory levels and distribution channels. The reports for manufacturers may include: retail sales by retailer, region, state, at large or other demographic area, retail sales by customer type/demographic, online sales by demographic, sales of promotional priced items, sales compared to competition, or other data.

The analysis may also be made available to the distribution chain to help them understand similar information including warehousing needs by region, product mix, delivery needs, ordering and inventory controls.

The information will also affect communication to the marketplace through, for example, advertising, branding, and product offers. The business hub facilitates communication between manufacturers/vendors and distributors to retailers through business to business ads, changed seamlessly by retailers to business to customer ads, database updating, and promotional pricing updates, as well as in-program messaging, banner ads, notices, offers, and critical notices.

The effectiveness of the right communication to retailers and consumers starts the cycle all over again which drives consumer purchasing decisions which are then recorded as real transactional data and reported back to the channel for continued refinement. Changes in trends are immediately realized to minimize obsolescence and maximize production, distribution, sales and profit potential.

The web service of the business hub follows common web standards to simplify its use by the greatest number of POS systems. The service is preferably secure. The service preferably consists of two separate methods. The first method allows retailers' POS systems to upload inventory change data (e.g. initial levels, sales, returns, adjustments, or other data). The second method allows retailers' POS systems to download a snapshot of their current inventory levels in the business hub system. The download may comprise UPC-quantity pairs.

Retailers, in a retailer interface, may have the ability to filter the website by manufacturer, product category, item, number, UPC code, geographical area, and time period. Retailers may be able to only view aggregate sales data. The retailer interface may show retailers which products are moving and how their stores compare to the industry at large. Manufacturers, in a manufacturer interface, will have the ability to filter the dashboard by product category, item number, UPC code, geographical area, and time period. Manufacturers may be only able to view aggregate sales data. The manufacturer interface may show manufacturers which products are moving in which areas, to help them set production schedules to more closely match demand.

### Third Parties

Third party services are linked to the business hub to provide various business services to business hub users. Retailers, manufacturers, consumers and distributors use services linked to the business hub, such as human resources (HR), printing, mailing, insurance, accounting, payroll, Internet service providers (ISP), point of sale (POS) systems, displays and shelving, to better manage their business. Business hub products and services may provide cost savings through bundled and pre-negotiated bulk pricing unavailable on an individual basis.

An administration interface may be used to set up and manage user account data. The administration interface may also contain the Home page customization controls. A user account information maintenance interface will provide users with ability to maintain basic account information such as name, address, email address, phone numbers, store name and password information. In addition to these, retailers will also use the administration interface to select which participating manufacturers are able to view data the retailer supplies. “All” manufacturers may be selected by default—retailers will then disable sharing to any specific manufactures. Furthermore the administration interface may allow managers to approve changes made by subordinates (e.g. price changes).

The business hub will provide social networking between retailers, manufacturers, vendors, distributors and other industry entities. Participants may link together, chat, and post information. A user forum may provide message boards to be used to ask questions and share information about best practices and anything else related to the industry. This area of the system may require someone with expertise in the industry to act as moderator.

The home page for the business hub website may be branded and may be customizable. Administrators may have the ability to control the background of the page and the site logo image in addition to other aspects. The Home page preferably will serve as a dashboard to access all business applications. It will also provide useful information including co-op dollars available, vendor ads, industry RSS feeds, and will include login capabilities.

A central website may be provided as a collection of business hub user's information, such as identity, information, location, advertisements and promotions, to facilitate and maximize Internet searching and search engine optimization (SEO).

In the preferred embodiment, all data in the business hub system will be stored in a relational database. The platform preferably will provide a high level of performance, reliability and data protection.

Item specification data is preferably updated periodically as new items are added to manufacturers' product lines. The update process is preferably available via a web service in a similar fashion to what is made available for updating retailer data. Item Specifications can include product category descriptions, manufacturer's model number, unit-of-measure, or other identifying information. Additionally, items can be classified under two or more categories. The system also includes any other product data the system is designed to display, outside of what is updated via the business hub web service. UPC codes may be used as the key identifying item attribute to distinguish items from one another. The system will track inventory by the smallest unit size. The capability may exist to create bundled items, and show the linked items at order time as one SKU. The system may have the ability to produce labels for a group of items. Groups can be defined, or delineated by manufacture, department, or other grouping.

Automated ordering can be included in a preferred embodiment of the business hub. The min/max levels can be defined and automatically populated across 12 months or another time period, the user could then adjust the period for seasonal variation. The min/max can be used for automatic ordering as well as manual orders. The time required to reach the minimum level can be used in the calculation of the re-order quantity.

The system may have the ability to recall receipts based on the printed bar code on the receipt, by phone number or the name. The system may contain an interface to an email service and may have the ability to associate multiple email addresses to an individual. A gift registry component can be provided in the business hub. The registry can be accessed in store either through an intranet or the Internet, and can be made available externally through a website with real time registry additions and purchase removal. In a preferred embodiment, the system may suggest additional items to sell along with purchased or rented items.

The system preferably will have the capability to notify customers electronically through email or text when a layaway payment is due, or if a work order is completed and any other task that requires notification. Preferably, the system can recall multiple layaways, special orders and/or work orders into one transaction. In a preferred embodiment, an image of a scanned item may appear on a screen.

The system may have the ability to define employee discounts based on item group. The system can also track employee purchases and set employee discounts. Every transaction preferably will be associated with a specific user (employee).The system preferably will be able to calculate commissions, e.g. based on gross profit. The system may have time clock capabilities.

The system may also include: alphabetization of menus, the ability to set specific days for the start of sales, allow for multiple web-stores from one feed, tracking and reporting employee activities within the system, applicability to work with a price scan kiosk for the customer to check prices on untagged items, ability to change price labels (price1, price2, etc.), the ability to handle growing UPC code fields, the ability to automatically logout after “x” number of seconds if screen is inactive, consignment fees may be set by store to be automatically calculated for single and multiple sales of items from the same customer, the ability to send notifications of special orders automatically to a designated person (with the option of having a secondary person) via text or email, the ability to provide alerts on customer account (at register) when a special order item has been received, a training mode on register which will allow functions to be done without jeopardizing data, the ability to allow for unlimited local suspends (which would be used in the event of the register being used as a stand-alone), an Inventory Out function which generates an invoice (similar to Receive By Invoice but deducts inventory) allowing for FIFO or LIFO per store's preference, membership tracking including expiration dates and notifications of pending expirations, an image capturing and storage device for membership cards as well as digitally capturing driver's license.

Other embodiments and uses of the invention will be apparent to those skilled in the art from consideration of the specification and practice of the invention disclosed herein. All references cited herein, including all publications, U.S. and foreign patents and patent applications, are specifically and entirely incorporated by reference. It is intended that the specification and examples be considered exemplary only with the true scope and spirit of the invention indicated by the following claims. Furthermore, the term “comprising” includes the terms “consisting of” and “consisting essentially of,” and the terms comprising, including, and containing are not intended to be limiting.

1. A system disseminating data from a first entity to one or more additional entities, comprising:
a processor;
at least one database storing records of business transactions, wherein the database is in communication with the processor; and
software executing on the processor, wherein the software:
receives data from a business transaction recording system of a first entity;
parses the received data for new business transactions;
automatically updates the database to reflect the new business transactions; and
automatically disseminates the new business transactions to one or more additional entity.

2. The system of claim 1, wherein each entity is one of a retailer, consumer, distributor, manufacturer, wholesaler, producer, supplier, contractor, administrator or service provider.

3. The system of claim 1, wherein the business transaction recording system is at least one of an advertising and promotion system, a marketing and communication system, a point-of-sale (POS) system, an advertising program, a website, a loyalty program, Internet access, an ordering system, an education and training program, social media, a printing service, a mailing service, a distribution service, a media product, a data analysis system, a human resources service, a credit service, an insurance service, an accounting service, a payroll service and a management service.

4. The system of claim 1, wherein the processor is coupled to at least one of a local area network, a wide area network, a metropolitan area network, an intranet, or the Internet.

5. The system of claim 1, wherein the business transactions include at least one of products sold, quantity of product sold, pricing of the product, product discounts, products advertised, in which form products were advertised, which products sold were advertised, margins, website traffic, user profile, customer information, statistical data, historical data, transactional data, demographics, analytics, which ads were viewed online, which products were added to a shopping list, shopping cart, or purchased, inventory levels, age and quantities, competitive information, management criteria, manufacturing details, distributor information, industry trends, human resources, accounting, payroll, purchasing, insurance, printing, mailing, delivery, research and development, training, production, promotions, sales and marketing.

6. The system of claim 1, wherein the software provides an entity a business marketing plan.

7. The system of claim 6, wherein the business marketing plan is based on at least one of the entity's profile, demographic information, the data stored in the database, marketing profile information.

8. The system of claim 7, wherein the business marketing plan is updated based on changes to the database.

9. The system of claim 6, wherein the business marketing plan includes at least one of suggested budgets, suggested purchasing levels, suggested transactional timing, suggested inventory levels, suggested billing cycle, suggested business services, suggested synergistic partnerships, suggested expense increase or reduction, suggested advertising vehicles, suggested marketing message, suggested target market, suggested sale location, suggested product mix and adjustments, suggested pricing, suggested pricing adjustment, and suggested promotional pricing.

10. The system of claim 1, further comprising the software outputting at least one report.

11. The system of claim 10, wherein the at least one report contains at least one of sales by location, wholesaler, distributor, retailer, region, state, at large or other demographic area, price comparison, inventory level, expense, sales by customer type, profile or demographic, online sales by demographic, sales of promotional priced items, sales compared to competition, product manufactured, warehoused, distributed or shipped by region, state, or other statistic, analytic or demographic.

12. A method for business management, comprising, a processor:
compiling a database of records of business transactions;
receiving data from a business transaction recording system of a first entity;
parsing the received data to determine if the received data is a new business transaction;
automatically updating the database to reflect the new business transaction; and
automatically disseminating the new business transaction to one or more additional entities.

13. The method of claim 12, wherein each entity is one of a retailer, consumer, wholesaler, producer, supplier, contractor, distributor, manufacturer, administrator or service provider.

14. The method of claim 12, wherein the business transaction recording system is chosen from the group comprising advertising and promotion systems, marketing and communication systems, point-of-sale (POS) systems, advertising programs, websites, loyalty programs, Internet access, ordering systems, education and training programs, social media, email programs, software systems, printing services, mailing services, distribution services, media products, data analysis systems, and third party services including human resources, credit, insurance, accounting, payroll and management services.

15. The method of claim 12, wherein the processor is coupled to at least one of a local area network, a wide area network, a metropolitan area network, an intranet, or the Internet.

16. The method of claim 12, wherein the business transactions include at least one of products sold, quantity of product sold, pricing of the product, product discounts, products advertised, in which form products were advertised, which products sold were advertised, margins, website traffic, customer profile, demographics, analytics, which ads were viewed online, which products were added to a shopping list, shopping cart, or purchased, inventory levels, age and quantities, competitive information, management criteria, manufacturing details, distributor information, industry trends, human resources, accounting, payroll, purchasing, insurance, printing, mailing, delivery, research and development, training, production, promotions, sales and marketing.

17. The method of claim 12, further comprising providing an entity a business marketing plan.

18. The method of claim 17, wherein the business marketing plan is based on at least one of the entity's profile, demographic information, the data stored in the database, marketing profile information.

19. The method of claim 18, wherein the business marketing plan is updated based on changes to the database.

20. The method of claim 19, wherein the business marketing plan includes at least one of suggested budgets, suggested purchasing levels, suggested transactional timing, suggested inventory levels, suggested billing cycle, suggested business services, suggested synergistic partnerships, suggested expense increase or reduction, suggested advertising vehicles, suggested marketing message, suggested target market, suggested sale location, suggested product mix and adjustments, suggested retail pricing, suggested pricing adjustment, and suggested promotional pricing.

21. The method of claim 12, further comprising outputting at least one report.

22. The method of claim 21, wherein the at least one report contains at least one of retail sales by location, wholesaler, distributor, retailer, region, state, at large or other demographic area, price comparison, inventory level, expense, sales by customer type, profile or demographic, online sales by demographic, sales of promotional priced items, sales compared to competition, product manufactured, warehoused, distributed or shipped by region, state, or other statistic, analytic or demographic.

23. A computer-readable media containing program instructions for business management, that causes a processor to:
compile a database of records of business transactions;
receive data from a business transaction recording system of a first entity;
parse the received data to determine if the received data is a new business transaction;
automatically update the database to reflect the new business transaction; and
automatically disseminate the new business transaction to one or more additional entities.

24. The computer-readable media of claim 23, wherein each entity is one of a retailer, consumer, wholesaler, producer, supplier, contractor, distributor, manufacturer, administrator or service provider.

25. The computer-readable media of claim 23, wherein the business transaction recording system is chosen from the group comprising advertising and promotion systems, marketing and communication systems, point-of-sale (POS) systems, advertising programs, websites, loyalty programs, Internet access, ordering systems, education and training programs, social media, email programs, software systems, printing services, mailing services, distribution services, media products, data analysis systems, and third party services including human resources, credit, insurance, accounting, payroll and management services.

26. The computer-readable media of claim 23, wherein the processor is coupled to at least one of a local area network, a wide area network, a metropolitan area network, an intranet, or the Internet.

27. The computer-readable media of claim 23, wherein the business transactions include at least one of products sold, quantity of product sold, pricing of the product, product discounts, products advertised, in which form products were advertised, which products sold were advertised, margins, website traffic, customer profile, demographics, analytics, which ads were viewed online, which products were added to a shopping list, shopping cart, or purchased, inventory levels, age and quantities, competitive information, management criteria, manufacturing details, distributor information, industry trends, human resources, accounting, payroll, purchasing, insurance, printing, mailing, delivery, research and development, training, production, promotions, sales and marketing.

28. The computer-readable media of claim 23, wherein the computer-readable media further causes the processor to provide an entity a business marketing plan.

29. The computer-readable media of claim 28, wherein the business marketing plan is based on at least one of the entity's profile, demographic information, the data stored in the database, marketing profile information.

30. The computer-readable media of claim 29, wherein the business marketing plan is updated based on changes to the database.

31. The computer-readable media of claim 30, wherein the business marketing plan includes at least one of suggested budgets, suggested purchasing levels, suggested transactional timing, suggested inventory levels, suggested billing cycle, suggested business services, suggested synergistic partnerships, suggested expense increase or reduction, suggested advertising vehicles, suggested marketing message, suggested target market, suggested sale location, suggested product mix and adjustments, suggested retail pricing, suggested pricing adjustment, and suggested promotional pricing.

32. The computer-readable media of claim 23, wherein the computer-readable media further causes the processor to output at least one report.

33. The computer-readable media of claim 32, wherein the at least one report contains at least one of sales by location, wholesaler, distributor, retailer, region, state, at large or other demographic area, price comparison, inventory level, expense, sales by customer type, profile or demographic, online sales by demographic, sales of promotional priced items, sales compared to competition, product manufactured, warehoused, distributed or shipped by region, state, or other statistic, analytic or demographic.

34. A system disseminating data from a first business transaction system or more additional business transaction systems, comprising:
a processor;
at least one database storing records of business transactions, wherein the database is in communication with the processor; and
software executing on the processor, wherein the software:
receives data from a first business transaction system of a first entity;
parses the received data to determine if the received data is a new business transaction;
automatically updates the database to reflect the new business transaction; and
automatically disseminates the new business transaction to one or more additional business transaction systems.

35. The system of claim 34, wherein the data is automatically disseminated to one or more additional entities.
